(19) United States
(12) Patent Application Publication
(10) Pub. No.: US 2026/0064285 A1
(43) Pub. Date: Mar. 5, 2026

(54) METHODS AND SYSTEMS FOR IMPROVING TERABYTES WRITTEN (TBW) OF A NAND BASED STORAGE DEVICE

(71) Applicant: Samsung Electronics Co., Ltd., Suwon-si (KR)

(72) Inventors: Rowen Alphonso Pereira, Bengaluru (IN); Uttam Neelakanth Kuntoji, Bengaluru (IN)

(21) Appl. No.: 18/931,330

(22) Filed: Oct. 30, 2024

(30) Foreign Application Priority Data
Sep. 4, 2024 (IN) 202441066836

(51) Int. Cl. G06F 3/06

(52) U.S. Cl. CPC G06F 3/0616; G06F 3/064; G06F 3/0659; G06F 3/0679

(57) ABSTRACT

The present disclosure relates to the field of storage devices and provides methods and systems for improving Terabytes Written (TBW) of a NAND based storage device. A block reallocating system monitors a Greatest Erase Count (GEC) of each independent block pool at intervals. Further, the block reallocating system determines a candidate independent block pool having a rate of increase of Erase Count (EC) higher than a rate of increase of EC of remaining ones of the plurality of independent block pools, based on the GEC. Further, it is determined whether the GEC of the candidate independent block pool and at least one independent block pool meet a reallocation condition, and then one or more free blocks are reallocated from the at least one independent block pool to the candidate independent block pool for improving TBW of the NAND based storage device.

### CROSS-REFERENCE TO RELATED APPLICATIONS

This application is based on and claims priority under 35 U.S.C. § 119 to Indian Patent Application number 202441066836, filed on Sep. 4, 2024, in the Indian Intellectual Property Office, the disclosure of which is incorporated by reference herein in its entirety.

### BACKGROUND OF THE INVENTION

The present disclosure relates to storage devices, and more particularly, to methods and systems for improving Terabytes Written (TBW) of a NAND based storage device.

In a NAND based storage device, Terabytes Written (TBW) is an amount of user data that is guaranteed by a manufacturer of the NAND based storage device before the device reaches its End of Life (EoL). In NAND based memory devices such as Solid-State Drives (SSDs), the TBW is estimated by counting the user data written by a host before MAX Erase Counts (EC) of the blocks reach the EC guaranteed by the non-volatile media (e.g., NAND). In the NAND based storage device, different data types such as meta data and user data are stored on different sets of blocks, also known as block pools, and each set has its own amount of Over Provisioning (OP) determined statically. For example, 8% for user data and 40% for meta data. TBW max is said to be reached when either of the block pools reaches their total MAX_EC.

It will be understood that the information disclosed in this background section is only for enhancement of understanding of the general background of the present disclosure and should not be taken as an acknowledgement or any form of suggestion that this information forms the prior art already known to a person skilled in the art.

### SUMMARY OF THE INVENTION

Provided is a method of improving Terabytes Written (TBW) of a NAND based storage device. According to some aspects of the present disclosure, the method comprises monitoring, by a block reallocating system, a Greatest Erase Count (GEC) of each of a plurality of independent block pools in a NAND based storage device at intervals. Further, the method comprises determining, by the block reallocating system, a candidate independent block pool among the plurality of independent block pools having a rate of increase of Erase Count (EC) higher than a rate of increase of EC of remaining ones of the plurality of independent block pools, based on the GEC of each of the plurality of independent block pools. In addition, the method comprises determining, by the block reallocating system, whether the GEC of the candidate independent block pool and the GEC of at least one independent block pool among the remaining ones of the plurality of independent block pools meet a reallocation condition. The method also comprises reallocating, by the block reallocating system, one or more free blocks from the at least one independent block pool to the candidate independent block pool when the candidate independent block pool and the at least one independent block pool meet the reallocation condition.

Further, provided is a block reallocating system for improving TBW of a NAND based storage device. According to some aspects of the present disclosure, the block reallocating system comprises a processor, and a memory communicatively coupled to the processor and configured to store instructions. Upon execution of the instructions, the processor is configured to monitor a GEC of each of a plurality of independent block pools in a NAND based storage device at intervals. Further, upon execution of the instructions, the processor is configured to determine a candidate independent block pool among the plurality of independent block pools having a rate of increase of EC higher than a rate of increase of EC of remaining ones of the plurality of independent block pools, based on the GEC of each of the plurality of independent block pools. In addition, upon execution of the instructions, the processor is configured to determine whether the GEC of the candidate independent block pool and the GEC of at least one independent block pool among the remaining ones of the plurality of independent block pools meet a reallocation condition. Upon execution of the instructions, the processor is also configured to reallocate one or more free blocks from the at least one independent block pool to the candidate independent block pool when the candidate independent block pool and the at least one independent block pool meet the reallocation condition.

In addition, provided is a method of increasing TBW capability of a NAND based storage device. According to some aspects of the present disclosure, the method comprises monitoring, by a memory block reallocating system, a GEC of each of a plurality of independent block pools in a NAND based storage device at intervals. Further, the method comprises determining, by the memory block reallocating system, a candidate independent block pool among the plurality of independent block pools having a rate of increase of EC higher than a rate of increase of EC of remaining ones of the plurality of independent block pools, based on the GEC of each of the plurality of independent block pools. In addition, the method comprises determining, by the memory block reallocating system, whether the GEC of the candidate independent block pool and the GEC of at least one independent block pool among the remaining ones of the plurality of independent block pools meet a reallocation condition. The method also comprises reallocating, by the memory block reallocating system, one or more free blocks from the at least one independent block pool to the candidate independent block pool when the candidate independent block pool and the at least one independent block pool meet the reallocation condition, said reallocating including selecting one of the remaining ones of the plurality of independent block pools having a lowest GEC for the reallocation when two or more of the remaining ones of the plurality of independent block pools meet the reallocation condition. The intervals may be set based on when the GEC of one or more of the plurality of independent block pools reaches a threshold percentage of a total MAX_EC pre-configured for the one or more of the plurality of independent block pools.

The foregoing summary is illustrative only and is not intended to be in any way limiting. In addition to that described above, further aspects of the present disclosure will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some embodiments of systems and/or methods in accordance with embodiments of the present disclosure are now described, by way of example only, and regarding the accompanying figures, in which:

FIG. 1 shows an illustration of an existing scenario of Terabytes Written (TBW) management in a NAND based storage device such as Solid-State Drive (SSD);

FIG. 2 shows an exemplary architecture for improving TBW of a NAND based storage device, in accordance with some embodiments of the present disclosure;

FIG. 3 shows a detailed block diagram of a block reallocating system, in accordance with some embodiments of the present disclosure;

FIG. 4 shows an exemplary flowchart illustrating a method of improving TBW of a NAND based storage device, in accordance with some embodiments of the present disclosure; and

FIG. 5 illustrates a general computer system architecture, in accordance with some embodiments of the present disclosure.

### DETAILED DESCRIPTION

In some aspects, NAND based storage devices may be usually used for a fixed workload over their lifetime, such as video editing, camera streaming, etc. Design changes during development (e.g., meta page size or LBA size) can cause an unpredictable EC increase in meta or user data blocks. Due to unpredictable usage scenarios and workloads of the NAND based storage devices, it may be difficult or impossible to accurately estimate which block pool will reach its total MAX_EC fast and plan its OP statically. If a block pool is overused, it reduces the TBW guarantee of the device. Further, providing active and continuous wear leveling between the block pools is not possible because of the presence of completely different data types.

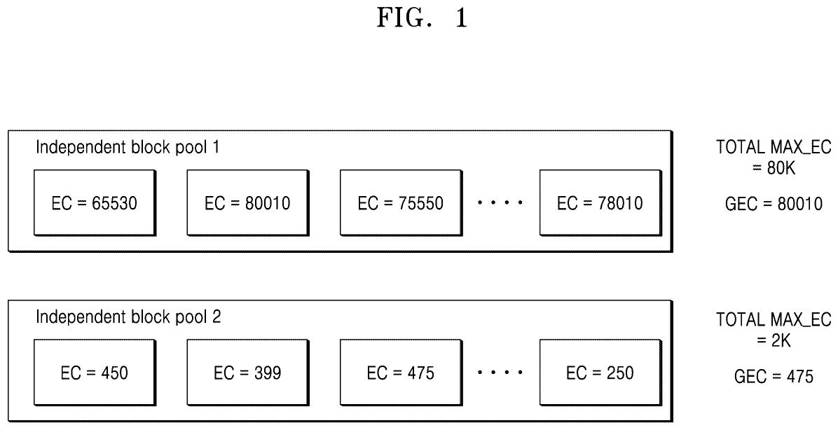

In FIG. 1, a NAND based storage device such as an SSD is considered to illustrate the present situation of block pools in the SSD. As shown in FIG. 1, metadata which is reliable data of the SSDs is stored in a separate block pool, i.e., independent block pool 1 and user data is stored in independent block pool 2. Consider that the total MAX_EC of the independent block pool 1 is 80K˜100K and the total MAX_EC of the independent block pool 2 is 2K˜4K. In the scenario illustrated in FIG. 1, EC of the metadata block pool has exceeded the total MAX_EC of 80K while the EC of the user data pool is still unused to its complete potential. As one of the block pools has reached the total MAX_EC, the SSD becomes unreliable for use.

Some techniques may provide a mechanism of dynamic wear leveling within the independent block pools. As part of the dynamic wear leveling, the blocks whose EC is higher than the EC of the other blocks within the independent block pool are detected and it is ensured that in the upcoming write cycles, the data is written into a block of the independent block pool other than the block detected with the highest EC. However, this mechanism may provide wear leveling within the independent block pool but not address the problem of block pool overuse. This means that, while the wear leveling is performed dynamically within the independent block pool, this wear leveling cannot stop other block pools from reaching the total MAX_EC at a faster rate, which reduces the lifetime of the NAND based storage device, thereby leading to underutilization of the NAND based storage device when compared to its actual potential.

Therefore, there is a need to provide a mechanism that reduces EC increase rate to achieve higher TBW of the NAND based storage device.

In the present disclosure, the word “exemplary” is used herein to mean “serving as an example, instance, or illustration.” Any embodiment or implementation of the present disclosure described herein as “exemplary” is not to be construed as preferred or advantageous over other embodiments.

It should be appreciated by those skilled in the art that any block diagrams herein represent conceptual views of illustrative systems embodying the principles of the present disclosure. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

While the present disclosure may have various modifications and alternative forms, specific embodiments thereof have been shown by way of example in the drawings and will be described in detail below. It should be understood, however, that the embodiments are not intended to limit the disclosure to the specific forms disclosed, but on the contrary, the present disclosure is intended to cover all modifications, equivalents, and alternatives falling within the scope of the disclosure.

The terms “comprises”, “comprising”, “includes”, “including”, “has”, “having”, or any other variations thereof are intended to cover a non-exclusive inclusion, such that a setup, device, or method that comprises a list of components or steps does not include only those components or steps but may include other components or steps not expressly listed or inherent to such setup, device, or method. In other words, one or more elements in a system, apparatus, or method preceded by the term “comprises” does not preclude the existence of other elements in the system, apparatus, or method.

In some aspects, there is a need to provide a mechanism that reduces Erase Count (EC) increase rate to achieve higher Terabytes Written (TBW) of a NAND based storage device. In NAND based storage devices, data writing includes erasing the already written data and rewriting when new data needs to be written into the NAND based storage devices. Therefore, each cycle of erasing and writing the data is considered as the EC. In the present disclosure, a block reallocating system is configured to monitor a Greatest Erase Count (GEC) of each of a plurality of independent block pools in a NAND based storage device at intervals, such that the block reallocating system can enable block reallocation between the independent block pools. The block reallocation between the independent block pools ensures effective utilization of data blocks as the block allocation in the independent block pools is not static, but instead is adjustable based on the GEC of each of the plurality of independent block pools. This enables detecting and reallocating the less used or unused blocks from other independent block pools to the independent block pool that is estimated to reach the total MAX_EC faster than the other independent block pools. Such block reallocation between the independent block pools ensures over provisioning at the right time independent block pools that are prone to reaching the total MAX_EC faster than the other independent block pools, which increases the TBW and lifetime of the NAND based storage devices.

In the following detailed description of example embodiments of the present disclosure, reference is made to the accompanying drawings that form a part hereof, and in which are shown by way of illustration specific embodiments in which the present disclosure may be practiced. These embodiments are described in sufficient detail to enable those skilled in the art to practice the present disclosure, and it is to be understood that other embodiments may be utilized and that changes may be made without departing from the scope of the present disclosure. The following description is, therefore, not to be taken in a limiting sense.

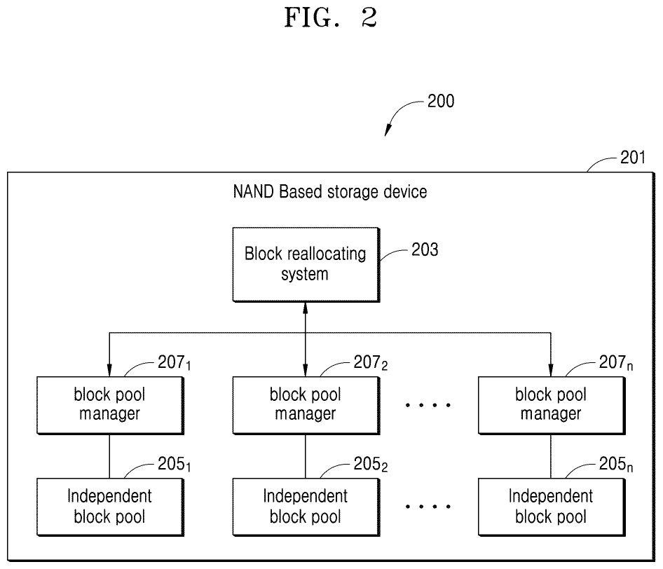

FIG. 2 shows an exemplary architecture for improving TBW of a NAND based storage device, in accordance with some embodiments of the present disclosure.

Referring to FIG. 2, architecture 200 includes a NAND based storage device 201. The NAND based storage device 201 includes a block reallocating system 203, independent block pool 205₁ to independent block pool 205ₙ (collectively referred to as a plurality of independent block pools 205), and block pool manager 2071 to block pool manager 207n corresponding to each of the plurality of independent block pools 205. In some embodiments, the NAND based storage device 201 may include, but is not limited to, Solid State Drive (SSD), embedded MultiMedia Card (eMMC) and/or Universal Flash Storage (UFS). In some embodiments, each of the plurality of independent block pools 205 may be configured to store different types of data. For instance, one of the independent block pool 205₁ may be a user data block pool that stores only user data. Another independent block pool 2052 may be a meta data block pool that stores only meta data. Similarly, each independent block pool 205ₙ may store different data type. Further, each of the plurality of independent block pools 205 may be configured with a corresponding number of blocks for storing data of a specific data type, and a MAX EC. As an example, the independent block pool 205₁ may be configured with a total MAX_EC of 80K˜100K and the number of blocks may be 50. Similarly, the independent block pool 2052 may be configured with a total MAX_EC of 2K˜4K and the number of blocks may be 100. Further, the block pool managers 207 associated with each of the plurality of independent block pools 205 are communicatively associated with the block reallocating system 203 to enable the block reallocating system 203 to perform methods of improving TBW of the NAND based storage device 201 in the present disclosure. As used herein, “a total MAX_EC” may refer to a total maximum erase count guaranteed for an independent block pool by the NAND based storage device 201. The total MAX_EC may be pre-configured for the independent block pool. For example, the total MAX_EC may be reached or exceeded when a highest value among current ECs of a plurality of blocks included in the independent block pool is greater than or equal to the total MAX_EC.

In the present disclosure, the block reallocating system 203 may communicate with the corresponding block pool managers 207 of each of the plurality of independent block pools 205 to monitor a Greatest Erase Count (GEC) of each of the plurality of independent block pools 205 in the NAND based storage device 201 at intervals. Here, the term interval is not limited to a temporal term. As an example, the interval may be defined in terms of MAX_EC percentage. As an example, a first interval may be when the GEC of an independent block pool 205ₙ reaches 30% of the total MAX_EC of the independent block pool 205ₙ. Similarly, as an example, a second interval may be when the GEC of the independent block pool 205ₙ reaches 60% of the total MAX_EC of the independent block pool 205ₙ. Also, the interval may be pre-defined or configured. Similarly, the intervals in terms of MAX_EC percentage may be configured as per requirement at the stage of manufacturing. As used herein, “GEC” may refer to a maximum erase count for an independent block pool in the NAND based storage device 201. For example, the GEC may be a highest value among current ECs of a plurality of blocks included in the independent block pool. Each of the plurality of blocks included in the independent block pool may have a current EC.

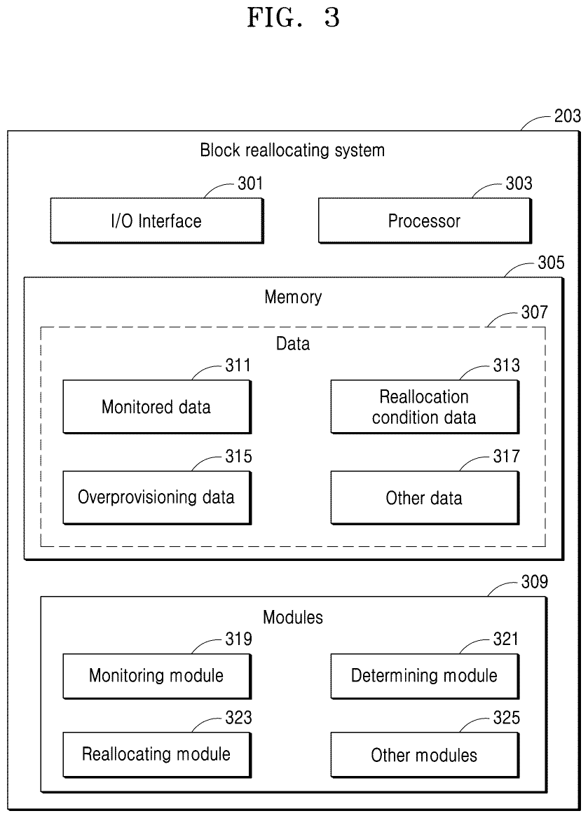

In some embodiments, the block reallocating system 203 may thereafter determine a candidate independent block pool among the plurality of independent block pools 205 having a rate of increase of EC higher than the rate of increase of EC of remaining ones of the plurality of independent block pools 205, based on the GEC of each of the plurality of independent block pools 205. In some embodiments, the GEC is the EC count of an independent block pool at the current time instant. Thereafter, the block reallocating system 203 may determine whether the GEC of the candidate independent block pool and at least one independent block pool of the remaining ones of the plurality of independent block pools 205 meet a re-allocation condition. Here, the re-allocation condition may be pre-defined or configured. Upon determining that the candidate independent block pool and the at least one independent block pool meet the re-allocation condition, the block reallocating system 203 may reallocate one or more free blocks from the at least one independent block pool to the candidate independent block pool for improving TBW of the NAND based storage device 201. Methods and systems for improving TBW of the NAND based storage device are explained in more detail with reference to FIG. 3.

FIG. 3 shows a detailed block diagram of the block reallocating system 203, in accordance with some embodiments of the present disclosure.

Referring to FIGS. 2 and 3, in some embodiments, the block reallocating system 203 may include an I/O interface 301, a processor 303 and a memory 305. In some embodiments, the memory 305 may be communicatively coupled to the processor 303. The processor 303 may be configured to perform one or more functions of the block reallocating system 203, using the data 307 and the one or more modules 309 of the block reallocating system 203. In some embodiments, the memory 305 may store the data 307.

In some embodiments, the data 307 stored in the memory 305 may include, but is not limited to, monitored data 311, reallocation condition data 313, Over Provisioning (OP) data 315 and other data 317. In some implementations, the data 307 may be stored within the memory 305 in the form of various data structures. Additionally, the data 307 may be organized using data models, such as relational or hierarchical data models. The other data 317 may include various temporary data and files generated by the one or more modules 309.

In some embodiments, the monitored data 311 may store information related to GEC and total MAX_EC of each of a plurality of independent block pools 205 in the NAND based storage device 201. As an example, total MAX_EC of an independent block pool 205₁ may be 80K, and GEC of the independent block pool 205₁ as monitored at a interval may be 2K. In some embodiments, the GEC of the independent block pool may be equal to a highest value among current ECs of each of a plurality of blocks of the independent block pool.

In some embodiments, the reallocation condition data 313 may store information related to reallocation conditions. As an example, the reallocation condition may include a first threshold percentage, a second threshold percentage, etc. Here, the first threshold percentage or the second threshold percentage may be pre-defined or configured. The first threshold percentage may indicate a percentage fraction of the total MAX_EC. As an example, 30% of the total MAX_EC may be considered as the first threshold percentage. Further, the second threshold percentage may indicate a percentage fraction of the total MAX_EC relative to the first threshold percentage. As an example, if the first threshold percentage is 30%, then the second threshold percentage may be half of 30% or a quarter of 30%, etc. In some embodiments, the second threshold percentage is less than the first threshold percentage.

In some embodiments, the overprovisioning data 315 may store information related to a determined number of free blocks to be re-allocated from at least one independent block pool to the candidate independent block pool, a number of blocks in the independent block pool that is overprovisioned with the determined number of free blocks, details of the independent block pools from which the free blocks are re-allocated and details of the independent block pool that is overprovisioned with the free blocks.

In some embodiments, the data 307 may be processed by the one or more modules 309 of the block reallocating system 203. In some embodiments, the one or more modules 309 may be communicatively coupled to the processor 303 for performing one or more functions of the block reallocating system 203. In some embodiments, the one or more modules 309 may include, but are not limited to, a monitoring module 319, a determining module 321, a reallocating module 323, and other modules 325.

As used herein, the term module may refer to an Application Specific Integrated Circuit (ASIC), an electronic circuit, a hardware processor (shared, dedicated, or group) and memory that execute one or more software or firmware programs, a combinational logic circuit, and/or other suitable components that provide the described functionality. In some embodiments, each of the one or more modules 309 may be configured as stand-alone hardware computing units. In some embodiments, the other modules 325 may be used to perform various miscellaneous functionalities on the block reallocating system 203. It will be appreciated that such one or more modules 309 may be represented as a single module or a combination of different modules.

In some embodiments, the monitoring module 319 may monitor a GEC of each of a plurality of independent block pools 205 in a NAND based storage device 201 at intervals. As an example, the interval may be defined in terms of MAX_EC percentage. As an example, a first interval may be when GEC of an independent block pool 205ₙ reaches 30% of the total MAX_EC of the independent block pool 205ₙ. Similarly, as an example, a second interval may be when GEC of the independent block pool 205ₙ reaches 60% of the total MAX_EC of the independent block pool 205ₙ. Similarly, the intervals in terms of MAX_EC percentage may be configured as per requirement at the stage of manufacturing.

In some embodiments, the determining module 321 may determine a candidate independent block pool 205ₙ among the plurality of independent block pools 205 having a rate of increase of EC higher than the rate of increase of EC of remaining ones of the plurality of independent block pools 205, based on the current MAX_EC of each of the plurality of independent block pools 205. As an example, consider the current MAX_EC of an independent block pool 205₁ is at 25% of the total MAX_EC of the independent block pool 205₁, the current MAX_EC of an independent block pool 205₂ is at 10% of the total MAX_EC of the independent block pool 205₂ and the current MAX_EC of an independent block pool 205₃ is at 5% of the total MAX_EC of the independent block pool 205₃. This means that the rate of increase of EC of the independent block pool 205₁, which is at 25% of the total MAX_EC of the independent block pool 205₁, is higher than the rate of increase of EC of the independent block pools 205₂ and 205₃.

In some embodiments, the determining module 321 may further determine whether the current MAX_EC of the candidate independent block pool 205ₙ and at least one independent block pool of the remaining ones of the plurality of independent block pools 205 meet a re-allocation condition. For this determination, initially, the determining module 321 may determine whether the current MAX_EC of the candidate independent block pool 205ₙ is greater than or equal to a first threshold percentage of a total MAX_EC pre-configured for the candidate independent block pool 205ₙ. As an example, 30% of the total MAX_EC of an independent block pool may be considered as the first threshold percentage. When the current MAX_EC of the candidate independent block pool 205ₙ is greater than or equal to a first threshold percentage of a total MAX_EC pre-configured for the candidate independent block pool 205ₙ, the determining module 321 may determine whether the current MAX_EC of the at least one independent block pool among the plurality of independent block pools 205 (apart from the candidate block pool 205ₙ) is less than a second threshold percentage of a total MAX_EC configured for the at least one independent block pool. Further, the second threshold percentage may indicate a percentage fraction of the total MAX_EC relative to the first threshold percentage, and is less than the first threshold percentage. As an example, if the first threshold percentage is 30%, then the second threshold percentage may be half of 30% or a quarter of 30%, etc. Therefore, through the reallocation condition of the second threshold percentage, the determining module 321 may determine whether there is at least one independent block pool whose GEC is less than the second threshold of the total MAX_EC preconfigured for the corresponding at least one independent block pool, when the current MAX_EC of the candidate independent block pool 205ₙ is greater than or equal to the first threshold percentage of the total MAX_EC pre-configured for the candidate independent block pool 205ₙ. Adherence to the aforementioned reallocation conditions ensures that the determining module 321 determines presence of a substantive difference between the usage of the independent block pools before initiating reallocation of one or more free blocks between the independent block pools 205.

In some embodiments, the reallocating module 323 may reallocate one or more free blocks from the at least one independent block pool to the candidate independent block pool 205ₙ for improving TBW of the NAND based storage device 201, when the candidate independent block pool 205ₙ and the at least one independent block pool meet the re-allocation condition. In some embodiments, the one or more free blocks are reallocated to the candidate independent block pool 205ₙ from the at least one independent block pool whose GEC is less than the second threshold percentage. In some embodiments, to reallocate the one or more free blocks from the at least one independent block pool to the candidate independent block pool 205ₙ, the reallocating module 323 may determine a number of free blocks to be re-allocated from the at least one independent block pool to the candidate independent block pool 205ₙ. The number of the one or more free blocks to be reallocated is determined based on the GEC of the candidate independent block pool 205ₙ and at least one independent block pool, a number of free blocks currently available in the candidate independent block pool 205ₙ, a number of free blocks currently available in the at least one independent block pool, and a first threshold percentage and a second threshold percentage of the reallocation condition. In some embodiments, the reallocating module 323 may use the below Equation 1 to determine the number of the one or more free blocks to be retained in the at least one independent block pool upon reallocating one or more free blocks to the candidate independent block pool 205ₙ:

$$NEW\_OP = ( ( TH - X ) / TH ) * OLD\_OP \qquad Equation 1$$

In the above Equation 1,
NEW_OP refers to the number of the one or more free blocks to be retained in the at least one independent block pool selected for overprovisioning the candidate independent block pool 205ₙ upon reallocating free blocks;
TH refers to the first threshold percentage. For instance, during a first interval of monitoring, if the first threshold percentage is 30%, during a second interval of monitoring, the first threshold percentage may be 60%. Accordingly, the TH value in the Equation 1 may be 30, 60, etc., based on the intervals at which the monitoring for the purpose of reallocation of free blocks between the independent block pools for overprovisioning is initiated;
X=TH−Percentage of GEC of other independent block pool. For instance, consider the percentage of GEC of the at least one independent block pool that met the second threshold percentage is 10% of its total MAX_EC. Then

$$X = TH - 10 .$$

OLD_OP refers to the number of free blocks currently available in the at least one independent block pool selected for overprovisioning the candidate independent block pool 205ₙ.

Thereafter, the number of free blocks to be reallocated to the candidate independent block pool 205ₙ is determined based on the below Equation 2.

$$Number of free blocks to be reallocated = OLD\_OP - NEW\_OP \qquad Equation 2$$

In some embodiments, upon determining the number of free blocks to be reallocated, the reallocating module 323 may reallocate the one or more free blocks equal to the determined number of free blocks from the at least one independent block pool to the candidate independent block pool 205ₙ, for improving TBW of the NAND based storage device 201. The reallocation results in overprovisioning the candidate independent block pool 205ₙ.

In some embodiments, if there is more than one independent block pool that meets the second threshold percentage when the candidate independent block pool 205ₙ meets the first threshold percentage, the reallocating module 323 may determine any one independent block pool from which the one or more free blocks need to be reallocated to the candidate independent block pool 205ₙ. As an example, consider there are two independent block pools 205₁ and 205₂ which meet the second threshold percentage. In some embodiments, the reallocation module 323 may select one of the two independent block pools 205₁ and 205₂ based on a priority. Here, the priority may be pre-defined or configured. For instance, the priority may indicate that, for the candidate independent block pool 205ₙ, first consider the independent block pool 205₁ and then the independent block pool 205₂. In such cases, as per the priority, the reallocation module 323 may select the independent block pool 205₁ for reallocation. In other embodiments, the reallocation module 323 may select one of the two independent block pools 205₁ and 205₂ based on the GEC. For instance, if the GEC of the independent block pool 205₁ is 14% and the GEC of the independent block pool 205₂ is 10%, then since the GEC of the independent block pool 205₂ is less than the GEC of the independent block pool 205₁, the reallocation module 323 may select the independent block pool 205₂ for reallocation. The aforementioned embodiments for selecting the independent block pool for reallocation should not be construed as a limitation of the present disclosure as any other selection criteria suitable in the context of the present disclosure may be applied.

Hereinafter, methods of improving TBW of a NAND based storage device are explained with the help of an example. However, this should not be construed as a limitation of the present disclosure.

Consider the scenario as explained in the below Table 1, at the first interval of 30%.

TABLE 1

| | Total | | First | Second | Current |
|---|---|---|---|---|---|
| Independent | MAX_EC | | threshold | threshold | number of |
| block pool | (TMX) | | percentage | percentage | free blocks |
| number | value | GEC | (TH) | (TH/2) | (OLD_OP) |
| Independent | TMX 1 | 31% of | 30% of | 15% of | 10 |
| Block Pool 1 | | TMX 1 | TMX 1 | TMX 1 | |
| (IBP 1) | | | | | |
| Independent | TMX 2 | 10% of | 30% of | 15% of | 85 |
| Block Pool 2 | | TMX 2 | TMX 2 | TMX 2 | |
| (IBP 2) | | | | | |
| Independent | TMX 3 | 25% of | 30% of | 15% of | 70 |
| Block Pool 3 | | TMX 3 | TMX 3 | TMX 3 | |
| (IBP 3) | | | | | |

As per the above Table 1, GEC of IBP 1 is greater than the TH. Hence, IBP 1 meets the first threshold percentage. Further, the GEC of IBP 2 is less than TH/2 and the GEC of IBP 3 is more than TH/2. Hence, IBP 2 meets the second threshold percentage and IBP 3 does not meet the second threshold percentage. Therefore, blocks IBP 1 and IBP 2 meet the reallocation condition, i.e.,

$$( IBP 1 > TH ) \&\& ( IBP 2 < TH / 2 )$$

As there is only one independent block pool, i.e., IBP 2 whose GEC is less than TH/2, the one or more free blocks to be reallocated to the IBP 1 are selected from IBP 2. As an example, the number of free blocks that should remain in the IBP 2 post the reallocation of free blocks to IBP 1 is determined based on the Equation 1 as shown below:

$$NEW\_OP = ( ( TH - X ) / TH ) * OLD\_OP \qquad Equation 1$$

X=TH−Percentage of GEC of other independent block pool
In this scenario, X=30−(GEC of IBP 2)

$$X = 30 - 10 = 20$$

$$NEW\_OP = ( ( 30 - 20 ) / 30 ) * 85 ) = 0.33 * 85 = 28 \text{.33} = 29 ( rounded off value )$$

In view of the above calculation, 29 free blocks should remain in IBP 2 post reallocation. Hence, based on the Equation 2, a total of (85−29)=56 free blocks are determined to be reallocated from IBP 2 to IBP 1, i.e., a difference of currently available free blocks in IBP 2 and the number of free blocks that are determined to be retained in the IBP 2.

Consider the scenario as explained in the below Table 2, at the second interval of 60%.

TABLE 2

| | Total | | First | Second | Current |
|---|---|---|---|---|---|
| Independent | MAX_EC | | threshold | threshold | number of |
| block pool | (TMX) | | percentage | percentage | free blocks |
| number | value | GEC | (TH) | (TH/2) | (OLD_OP) |
| Independent | TMX 1 | 63% of | 60% of | 30% of | 5 |
| Block Pool 1 | | TMX 1 | TMX 1 | TMX 1 | |
| (IBP 1) | | | | | |
| Independent | TMX 2 | 28% of | 60% of | 30% of | 65 |
| Block Pool 2 | | TMX 2 | TMX 2 | TMX 2 | |
| (IBP 2) | | | | | |
| Independent | TMX 3 | 25% of | 60% of | 30% of | 70 |
| Block Pool 3 | | TMX 3 | TMX 3 | TMX 3 | |
| (IBP 3) | | | | | |

As per the above Table 2, GEC of IBP 1 is greater than the TH. Hence, IBP 1 meets the first threshold percentage. Further, the GEC of IBP 2 is less than TH/2 and the GEC of IBP 3 is also less than TH/2. Hence, IBP 2 and IBP 3 meet the second threshold percentage. Therefore, blocks IBP 1, IBP 2 and IBP 3 meet the reallocation condition, i.e.,

$$( IBP 1 > TH ) \&\& ( IBP 2 and IBP 3 < TH / 2 )$$

As there are two independent block pools, i.e., IBP 2 and IBP 3 whose GEC is less than TH/2, the one or more free blocks to be reallocated to the IBP 1 are selected from either IBP 2 or IBP 3 based on a selection criteria. Here, the selection criteria can be pre-defined or configured. As an example, if the selection criteria is least GEC, then IBP 3 that has a lower current MAX_EC compared to IBP 2 is selected for the purpose of reallocation. As an example, the number of free blocks to be reallocated from IBP 3 to IBP 1 are determined based on the Equation 1 as shown below:

$$NEW\_OP = ( ( TH - X ) / TH ) * OLD\_OP \qquad Equation 1$$

X=TH−Percentage of GEC of other independent block pool
In this scenario, X=60−(GEC of IBP 3)

$$X = 60 - 25 = 35$$

$$NEW\_OP = ( ( 60 - 35 ) / 60 ) * 70 ) = 29.16 = 30 ( rounded off value )$$

In view of the above calculation, based on Equation 2, a total of 70−30=40 free blocks are determined to be reallocated from IBP 3 to IBP 1, while 30 free blocks are determined to be retained in the IBP 3.

In some embodiments, instead of the Equation 1, the present disclosure may also use, without limitation, the below Equation 3.

$$NEW\_OP = ( Y / TH ) * OLD\_OP \qquad Equation 3$$

In the above Equation 3, Y refers to the percentage of GEC of the independent block pool from which the free blocks are determined to be reallocated to the candidate independent block pool.

For instance, the above calculation performed using Table 2 when performed using Equation 3, is shown below:

$$NEW\_OP = ( 25 / 60 ) * 70 = 29.16 = 30 ( rounded off value )$$

Hence, in view of the above calculation, based on Equation 2, a total of 70−30=40 free blocks are determined to be reallocated from IBP 3 to IBP 1, while 30 free blocks are determined to be retained in the IBP 3.

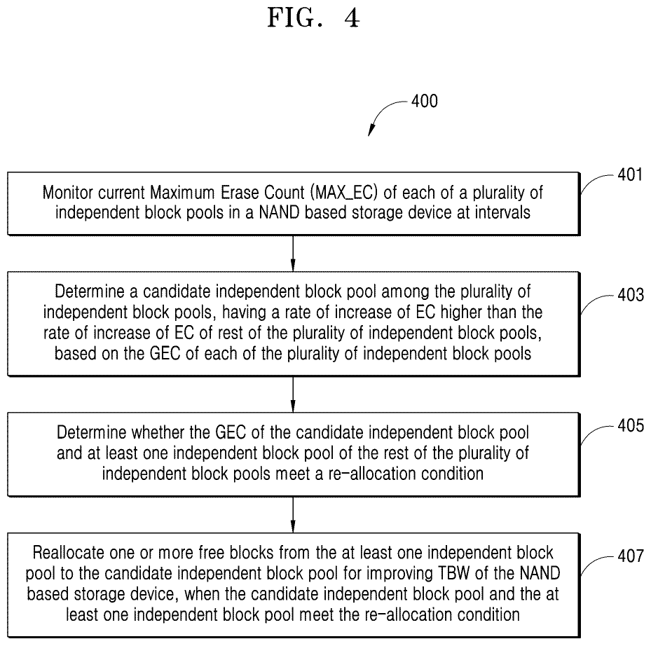

FIG. 4 shows a flowchart illustrating a method of improving TBW of a NAND based storage device, in accordance with some embodiments of the present disclosure.

Referring to FIGS. 2 to 4, the method 400 may include one or more blocks illustrating a method of improving TBW of a NAND based storage device 201 using the processor 303 configured in the NAND based storage device 201 shown in FIGS. 2 and 3. The method 400 may be described in the general context of computer executable instructions. For example, computer executable instructions can include routines, programs, objects, components, data structures, procedures, modules, and functions, which perform specific functions or implement specific abstract data types.

The order in which the method 400 is described is not intended to be construed as a limitation, and any number of the described method blocks can be combined in any order to implement the method 400. Additionally, individual blocks may be deleted from the method 400 without departing from the scope of the present disclosure. Furthermore, the method 400 can be implemented in any suitable hardware, software, firmware, or combination thereof.

At block 401, the method 400 includes monitoring, by a processor 303 of the NAND based storage device 201, a GEC (i.e., a maximum erase count (MAX_EC)) of each of a plurality of independent block pools 205 in a NAND based storage device 201 at intervals.

At block 403, the method 400 includes determining, by the processor 303, a candidate independent block pool 205ₙ among the plurality of independent block pools 205 having a rate of increase of EC higher than the rate of increase of EC of rest of (i.e., remaining ones of) the plurality of independent block pools 205, based on the GEC of each of the plurality of independent block pools 205.

At block 405, the method 400 includes determining, by the processor 303, whether the GEC of the candidate independent block pool 205ₙ and at least one independent block pool of the rest of (i.e., remaining ones of) the plurality of independent block pools 205 meet a re-allocation condition.

At block 407, the method 400 includes reallocating, by the processor 303, one or more free blocks from the at least one independent block pool to the candidate independent block pool 205ₙ for improving TBW of the NAND based storage device 201, when the candidate independent block pool 205ₙ and the at least one independent block pool meet the re-allocation condition.

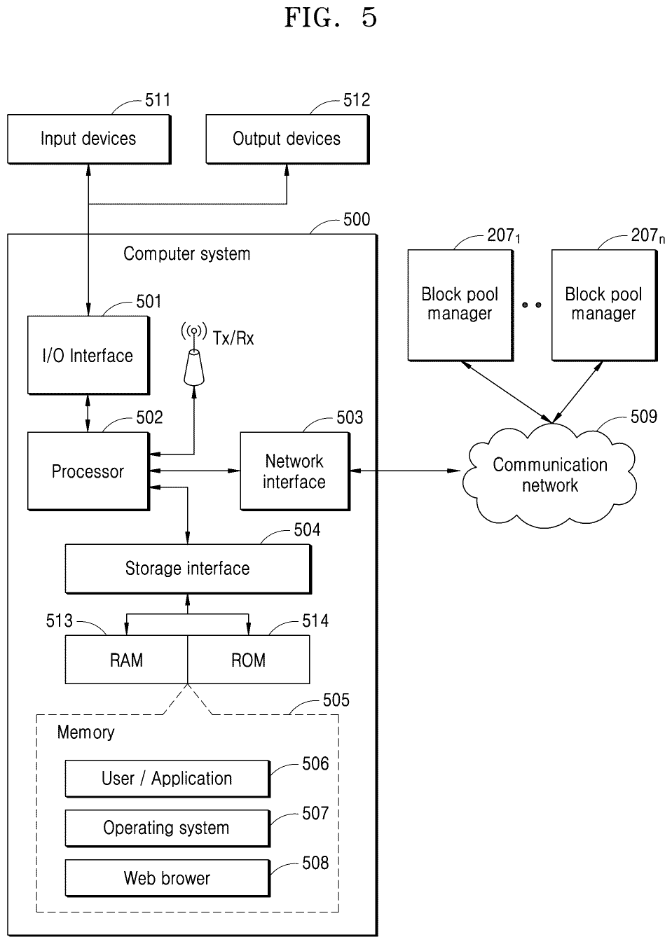

FIG. 5 illustrates a block diagram of an exemplary computer system 500 for implementing embodiments consistent with the present disclosure. Referring to FIG. 5, in some embodiments, the computer system 500 may be the NAND based storage device 201 illustrated in FIG. 2. As an example, the NAND based storage device 201 may be a non-volatile storage device such as Solid-State Devices (SSDs), memory cards, a Universal Flash Storage (UFS), an embedded Multi-Media Card (eMMC), Non-Volatile Memory express (NVMe) based devices and the like. The computer system 500 may include a central processing unit (“CPU” or “processor” or “memory controller”) 502. The processor 502 may include at least one data processor for executing program components for executing user- or system-generated business processes. A user may include a network manager, an application developer, a programmer, an organization or any system/sub-system being operated parallelly to the computer system 500. The processor 502 may include specialized processing units such as integrated system (bus) controllers, memory controllers/memory management control units, floating point units, graphics processing units, digital signal processing units, etc.

The processor 502 may be in communication with one or more Input/Output (I/O) devices (511 and 512) via I/O interface 501. The I/O interface 501 may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like, etc. Using the I/O interface 501, the computer system 500 may communicate with one or more I/O devices 511 and 512.

In some embodiments, the processor 502 may be in communication with a network 509 via a network interface 503. The network interface 503 may communicate with the network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc.

In some embodiments, the network 509 may be implemented as one of the several types of networks, such as intranet or Local Area Network (LAN) and such within the organization. The network 509 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 509 may include a variety of network devices, including routers, bridges, servers, computing devices, storage devices, etc. Using the network interface 503 and the network 509, the computer system 500 may communicate with a block pool manager 2071 to 207n.

In some embodiments, the processor 502 may be in communication with a memory 505 (e.g., RAM 513, ROM 514, etc., as shown in FIG. 5) via a storage interface 504. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user/application interface 506, an operating system 507, a web browser 508, and the like. In some embodiments, computer system 500 may store user/application data 506, such as the data, variables, records, etc. as described in the present disclosure. Such databases may be implemented as fault-tolerant, relational, scalable, secure databases such as Oracle® or Sybase® or PostgreSQL®.

The operating system 507 may facilitate resource management and operation of the computer system 500. Examples of operating systems include, but are not limited to, APPLE® MACINTOSH® OS X®, UNIX®, UNIX-like system distributions (e.g., BERKELEY SOFTWARE DISTRIBUTION® (BSD), FREEBSD®, NETBSD®, OPENBSD, etc.), LINUX® DISTRIBUTIONS (e.g., RED HAT®, UBUNTU®, KUBUNTU®, etc.), IBM® OS/20, MICROSOFT® WINDOWS® (XP®, VISTA®/7/8, 10, etc.), APPLE® IOS®, GOOGLE™ ANDROID™, BLACKBERRY® OS, or the like.

The user/application interface 506 may facilitate display, execution, interaction, manipulation, or operation of program components through textual or graphical facilities. For example, the user/application interface 506 may provide computer interaction interface elements on a display system operatively connected to the computer system 500, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., Acro, Metro, etc.), web interface libraries (e.g., ActiveX®, JAVA®, JAVASCRIPT®, AJAX, HTML, ADOBE® FLASH®, etc.), or the like.

The web browser 508 may be a hypertext viewing application. Secure web browsing may be provided using Secure Hypertext Transport Protocol (HTTPS), Secure Sockets Layer (SSL), Transport Layer Security (TLS), and the like. The web browser 508 may utilize facilities such as AJAX, DHTML, ADOBE® FLASH®, JAVASCRIPT®, JAVA®, Application Programming Interfaces (APIs), and the like. Further, the computer system 500 may implement a mail server stored program component. The mail server may utilize facilities such as ASP, ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

In some embodiments, methods and systems of the present disclosure determine a trigger point to initiate Garbage Collection (GC) and a value of the trigger point is different from the value to initiate urgent GC. This helps in mitigating blocking of the I/O path, as the I/O path is blocked during urgent GC. This also helps in preventing memory devices from entering a critical state where no I/O operations are performed as the I/O path is blocked during the urgent GC scenario.

Embodiments of the present disclosure may improve TBW of a NAND based storage device. In the present disclosure, a block reallocating system is configured to monitor a GEC of each of a plurality of independent block pools in a NAND based storage device at intervals, such that the block reallocating system can enable block reallocation between the independent block pools. The block reallocation between the independent block pools ensures effective utilization of data blocks as the block allocation in the independent block pools is not static, but instead is adjustable based on the GEC of each of the plurality of independent block pools. This enables detecting and reallocating the less used or unused blocks from other independent block pools to the independent block pool that is estimated to reach the total MAX_EC faster than the other independent block pools. Such block reallocation between the independent block pools ensures over provisioning at the right time independent block pools that are prone to reaching the total MAX_EC faster than the other independent block pools, which increases the TBW and lifetime of the NAND based storage devices.

As stated above, it shall be noted that methods and systems of the present disclosure may be used to overcome various technical problems related to non-volatile memory management. In other words, the methods and systems of the present disclosure have a practical application and provide a technically advanced solution to the technical problems associated with the existing approaches in non-volatile memory management.

In light of the technical advancements provided by the disclosed methods and systems, the claimed steps, as discussed above, are not routine, conventional, or well-known aspects in the art, as the claimed steps provide the aforesaid solutions to the technical problems existing in the conventional technologies. Further, the claimed steps clearly bring an improvement in the functioning of the system itself, as the claimed steps provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the present disclosure” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary, a variety of optional components are described to illustrate the wide variety of possible embodiments of the present disclosure.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively embodied by one or more other devices which are not explicitly described as having such functionality/features. Thus, other embodiments of the present disclosure need not include the device itself.

Finally, the language used in the specification has been principally selected for readability and instructional purposes, and it may not have been selected to delineate or circumscribe the inventive concepts. It is therefore intended that the scope of the present disclosure is not limited by this detailed description, but rather by the following claims. Accordingly, the example embodiments of the present disclosure are intended to be illustrative, but not limiting, of the scope of the present disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the scope of the present disclosure being indicated by the following claims.

We claim:

1. A method of improving Terabytes Written (TBW) of a NAND based storage device including a block reallocating system, the method comprising:
monitoring, by the block reallocating system, a Greatest Erase Count (GEC) of each of a plurality of independent block pools in a NAND based storage device at intervals;
determining, by the block reallocating system, a candidate independent block pool among the plurality of independent block pools having a rate of increase of Erase Count (EC) higher than a rate of increase of EC of remaining ones of the plurality of independent block pools, based on the GEC of each of the plurality of independent block pools;
determining, by the block reallocating system, whether the GEC of the candidate independent block pool and the GEC of at least one independent block pool among the remaining ones of the plurality of independent block pools meet a reallocation condition; and
reallocating, by the block reallocating system, one or more free blocks from the at least one independent block pool to the candidate independent block pool in response to the candidate independent block pool and the at least one independent block pool meeting the reallocation condition.

2. The method of claim 1, wherein determining whether the GEC of the candidate independent block pool and the GEC of the at least one independent block pool meet the reallocation condition comprises:
determining whether the GEC of the candidate independent block pool is greater than or equal to a first threshold percentage of a total MAX_EC pre-configured for the candidate independent block pool; and
determining whether the GEC of the at least one independent block pool is less than a second threshold percentage of a total MAX_EC pre-configured for the at least one independent block pool, wherein the second threshold percentage is less than the first threshold percentage.

3. The method of claim 2, wherein the one or more free blocks are reallocated to the candidate independent block pool from the at least one independent block pool having the GEC that is less than the second threshold percentage.

4. The method of claim 1, wherein reallocating the one or more free blocks from the at least one independent block pool to the candidate independent block pool comprises:
determining a number of free blocks to be reallocated from the at least one independent block pool to the candidate independent block pool, based on:
the GEC of the candidate independent block pool and the GEC of the at least one independent block pool,
a first threshold percentage and a second threshold percentage of the reallocation condition, and
a first number of free blocks currently available in the candidate independent block pool and a second number of free blocks currently available in the at least one independent block pool; and
reallocating the one or more free blocks equal to the determined number of free blocks from the at least one independent block pool to the candidate independent block pool, wherein the reallocation results in overprovisioning the candidate independent block pool.

5. The method of claim 1, wherein the GEC of a respective one of the plurality of independent block pools is a highest value among ECs of a plurality of blocks included in the respective one of the plurality of independent block pools.

6. A block reallocating system for improving Terabytes Written (TBW) of a NAND based storage device, the block reallocating system comprising:
a processor; and
a memory communicatively coupled to the processor and configured to store instructions,
wherein, upon execution of the instructions, the processor is configured to:
monitor a Greatest Erase Count (GEC) of each of a plurality of independent block pools in a NAND based storage device at intervals;
determine a candidate independent block pool among the plurality of independent block pools having a rate of increase of Erase Count (EC) higher than a rate of increase of EC of remaining ones of the plurality of independent block pools, based on the GEC of each of the plurality of independent block pools;
determine whether the GEC of the candidate independent block pool and the GEC of at least one independent block pool among the remaining ones of the plurality of independent block pools meet a reallocation condition; and
reallocate one or more free blocks from the at least one independent block pool to the candidate independent block pool when the candidate independent block pool and the at least one independent block pool meet the reallocation condition.

7. The block reallocating system of claim 6, wherein, to determine whether the GEC of the candidate independent block pool and the GEC of the at least one independent block pool meet the reallocation condition, the processor is configured to:
determine whether the GEC of the candidate independent block pool is greater than or equal to a first threshold percentage of a total MAX_EC pre-configured for the candidate independent block pool; and
determine whether the GEC of the at least one independent block pool is less than a second threshold percentage of a total MAX_EC pre-configured for the at least one independent block pool, wherein the second threshold percentage is less than the first threshold percentage.

8. The block reallocating system of claim 7, wherein the processor is configured to reallocate the one or more free blocks to the candidate independent block pool from the at least one independent block pool having the GEC that is less than the second threshold percentage.

9. The block reallocating system of claim 6, wherein, to reallocate the one or more free blocks from the at least one independent block pool to the candidate independent block pool, the processor is configured to:
determine a number of free blocks to be reallocated from the at least one independent block pool to the candidate independent block pool, based on:
the GEC of the candidate independent block pool and the GEC of the at least one independent block pool,
a first threshold percentage and a second threshold percentage of the reallocation condition, and
a first number of free blocks currently available in the candidate independent block pool and a second number of free blocks currently available in the at least one independent block pool; and
reallocate the one or more free blocks equal to the determined number of free blocks from the at least one independent block pool to the candidate independent block pool, wherein the candidate independent block pool is overprovisioned as a result of the reallocation.

10. The block reallocating system of claim 6, wherein the GEC of a respective one of the plurality of independent block pools is a highest value among ECs of a plurality of blocks included in the respective one of the plurality of independent block pools.

11. A method of increasing Terabytes Written (TBW) capability of a NAND based storage device, comprising the following performed by a memory block reallocating system:
monitoring a Greatest Erase Count (GEC) of each of a plurality of independent block pools in a NAND based storage device at intervals;
determining a candidate independent block pool among the plurality of independent block pools having a rate of increase of Erase Count (EC) higher than a rate of increase of EC of remaining ones of the plurality of independent block pools, based on the GEC of each of the plurality of independent block pools;
determining whether the GEC of the candidate independent block pool and the GEC of at least one independent block pool among the remaining ones of the plurality of independent block pools meet a reallocation condition; and
reallocating one or more free blocks from the at least one independent block pool to the candidate independent block pool when the candidate independent block pool and the at least one independent block pool meet the reallocation condition, said reallocating including selecting one of the remaining ones of the plurality of independent block pools having a lowest GEC for the reallocation when two or more of the remaining ones of the plurality of independent block pools meet the reallocation condition,
wherein the intervals are set based on when the GEC of one or more of the plurality of independent block pools reaches a threshold percentage of a total MAX_EC pre-configured for the one or more of the plurality of independent block pools.
